(19) United States
(12) Patent Application Publication
(10) Pub. No.: US 2026/0149508 A1
(43) Pub. Date: May 28, 2026

(54) METHOD AND APPARATUS FOR REGULATING POWER SUPPLIED BY A LOCAL OSCILLATOR SOURCE IN AN OPTICAL MODEM

(71) Applicant: CIENA CORPORATION, Hanover, MD (US)

(72) Inventors: Scott Kuntze, Ottawa (CA); Ronald Hartman, Fitzroy Harbour (CA); Michael Vitic, Chelsea (CA); Ian Betty, Ottawa (CA)

(73) Assignee: CIENA CORPORATION, Hanover, MD (US)

(21) Appl. No.: 18/960,609

(22) Filed: Nov. 26, 2024

(51) Int. Cl. H04B 10/69; H04B 10/61; H04J 14/02

(52) U.S. Cl. CPC H04B 10/693; H04B 10/614; H04J 14/02

(57) ABSTRACT

Aspects of the subject disclosure may include, for example, mixing a local oscillator (LO) signal produced by a LO source and an incoming optical signal to produce a received optical signal directed to one or more photodetectors to produce a photocurrent that is supplied to an amplifier, monitoring the photocurrent supplied to the amplifier, and responsive to the monitoring, causing the LO source to perform an adjustment of an optical power of the LO signal to control the photocurrent supplied to the amplifier to avoid an overload condition. Other embodiments are disclosed.

### FIELD OF THE DISCLOSURE

The subject disclosure relates to a method and apparatus for regulating power supplied by a local oscillator source in an optical modem.

### BACKGROUND

Traditional wavelength-division multiplexing (WDM) networks require precise wavelength tuning, necessitating expensive tunable lasers. These systems typically share a single tunable laser between the transmitter and receiver, allocating a portion of the laser's power to the receiver as it relates to a local oscillator source. This allocation often falls short of optimizing the receiver's signal-to-noise and distortion ratio (SNDR).

Datacenter networks, which utilize fewer wavelength channels, can employ lower-cost lasers with relaxed tuning precision. This configuration allows for dedicated lasers for both the transmitter and receiver, enabling increased power to improve SNDR. However, increasing power poses a risk of exceeding the operational limits of components in an optical modem, potentially leading to damage. Variations in responsivity over wavelength during tuning can further complicate this balance, necessitating a control mechanism to optimize SNDR while protecting sensitive components from overload.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of an optical modem in accordance with various aspects described herein.

FIGS. 2A and 2B show plots illustrating exemplary, non-limiting embodiments depicting operations of an optical modem in accordance with various aspects described herein.

FIG. 3 is a block diagram illustrating an exemplary, non-limiting embodiment of a receiver path of an optical modem in accordance with various aspects described herein.

FIG. 4 is a block diagram illustrating an exemplary, non-limiting embodiment of a detector of an amplifier in the optical modem of FIG. 3 in accordance with various aspects described herein.

FIG. 5A depicts an illustrative embodiment of a method utilized by an optical modem in accordance with various aspects described herein.

FIG. 5B depicts an illustrative embodiment of a method utilized by an optical modem in accordance with various aspects described herein.

### DETAILED DESCRIPTION

The subject disclosure describes, among other things, illustrative embodiments for optimizing signal-to-noise and distortion ratio (SNDR) of an optical modem while managing power supplied by a local oscillator source to prevent components of the optical modem from exceeding their operation range. Other embodiments are described below.

Optical communications involve the transmission of data using light signals through optical fibers. This field encompasses various technologies and methods to enhance data transmission efficiency, speed, and reliability. Optical modems play a crucial role in converting electrical signals to optical signals and vice versa, enabling high-speed data communication over long distances. Optical modems often employ components such as lasers, photodetectors, and amplifiers to facilitate the modulation and demodulation of light signals.

A challenge in optical modems includes managing the power levels of local oscillator sources to optimize SNDR while preventing damage to photodetectors and amplifiers. Variations in responsivity over different wavelengths can lead to fluctuations in photocurrent, posing further risks of overload. These challenges necessitate the development of control mechanisms to balance power optimization with component protection as will be addressed in the embodiments that follow.

One or more aspects of the subject disclosure includes a method for mixing a local oscillator (LO) signal produced by a LO source and an incoming optical signal to produce a received optical signal directed to one or more photodetectors to produce a photocurrent that is supplied to an amplifier. The method further includes monitoring the photocurrent supplied to the amplifier, and responsive to the monitoring, causing the LO source to perform an adjustment of an optical power of the LO signal to control the photocurrent supplied to the amplifier.

One or more aspects of the subject disclosure includes an optical modem that has a local oscillator (LO) source configured to produce a LO signal, a mixer configured to mix the LO signal and an incoming optical signal to produce a received optical signal, one or more photodetectors configured to produce a photocurrent from the received optical signal, an amplifier configured to generate an output signal based on the photocurrent, and a controller. The controller can be configured to perform operations including monitoring the photocurrent supplied to the amplifier, and responsive to the monitoring, causing the LO source to perform an adjustment of an optical power of the LO signal to control the photocurrent supplied to the amplifier.

One or more aspects of the subject disclosure includes a non-transitory machine-readable medium, comprising executable instructions that, when executed by a processing system including a processor, facilitate performance of operations. Such operations can include monitoring a measurement associated with a photocurrent supplied to an amplifier. The photocurrent can be produced by one or more photodetectors according to a received optical signal produced by mixing a local oscillator (LO) signal produced by a LO source and an incoming optical signal. The operations further include causing the LO source to perform an adjustment of an optical power of the LO signal to control the photocurrent supplied to the amplifier.

In one or more aspects of the subject disclosure the adjustment of the optical power of the LO signal prevents the photocurrent produced by the one or more photodetectors from exceeding an operational threshold.

In one or more aspects of the subject disclosure adjustment of the optical power of the LO signal adjusts the photocurrent produced by the one or more photodetectors to improve operation of an analog-to-digital converter (ADC) coupled to the amplifier.

In one or more aspects of the subject disclosure the monitoring of the photocurrent can be performed by a detection circuit that performs a measurement of the photocurrent. In one or more aspects of the subject disclosure the detection circuit can comprise a received signal strength indicator (RSSI) circuit. In one or more aspects of the subject disclosure the detection circuit has a tunable gain. In one or more aspects of the subject disclosure the above embodiments further include adjusting the tunable gain of the detection circuit to adjust the measurement produced by the detection circuit.

In one or more aspects of the subject disclosure the detection circuit is coupled to a pre-amplifier stage of the amplifier.

In one or more aspects of the subject disclosure the amplifier comprises a transimpedance amplifier.

In one or more aspects of the subject disclosure the amplifier has a tunable gain adjustable by a primary control loop, and the adjustment of the optical power of the LO signal is performed by a secondary control loop. In one or more aspects of the subject disclosure the adjustment of the optical power of the LO signal by the secondary control loop occurs at a substantially equal or slower rate than adjusting the tunable gain of the amplifier by the primary control loop.

In one or more aspects of the subject disclosure the LO source is not shared with a transmitter of the optical modem. In one or more aspects of the subject disclosure the LO source is shared between a receiver and a transmitter of the optical modem, and power generated by the LO source that is directed to the receiver is adjustable.

In one or more aspects of the subject disclosure the above embodiments further include tuning a wavelength of the LO source to match the incoming optical signal.

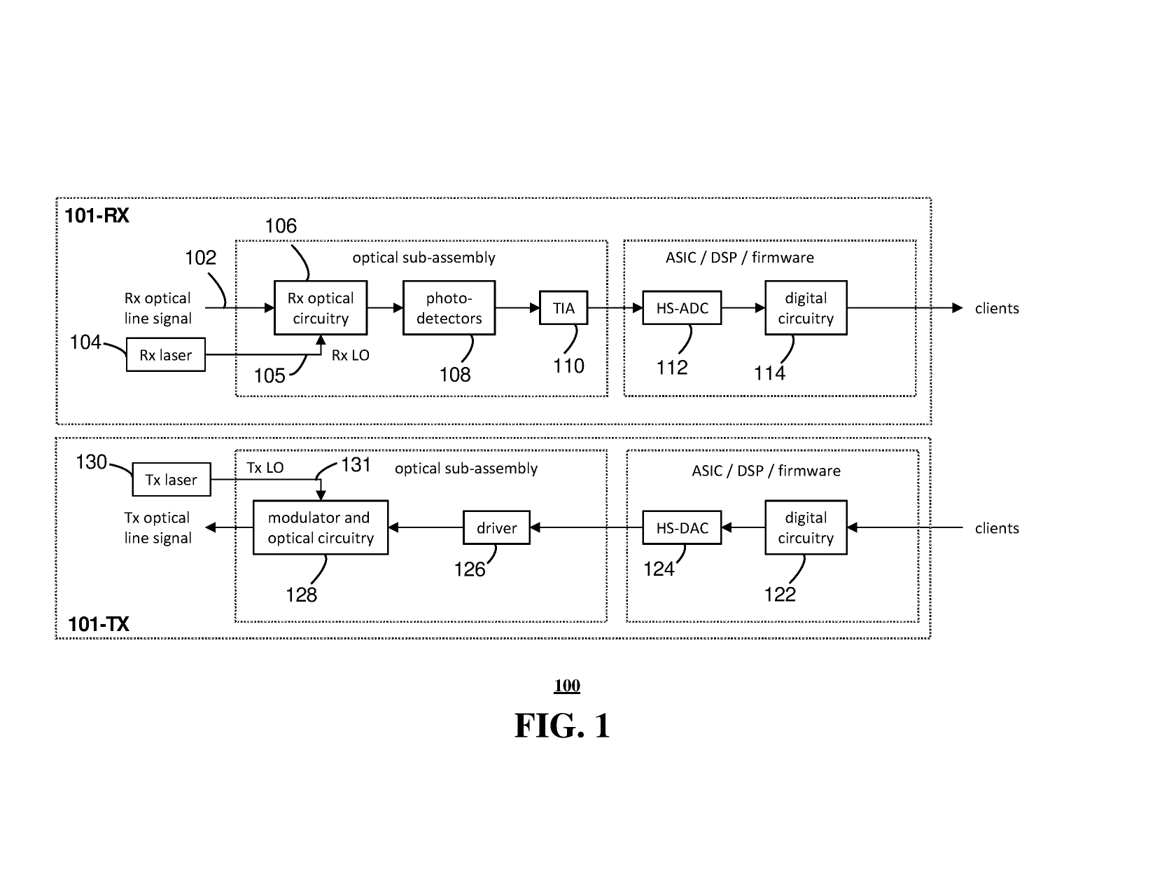

FIG. 1 is a block diagram illustrating an exemplary, non-limiting embodiment of an optical modem 100 in accordance with various aspects described herein. The optical modem 100 can include an optical sub-assembly section and an ASIC/DSP/Firmware section for a receiver path 101-RX and transmit path 101-TX. The receive path 101-RX includes a receiver (Rx) laser 104 that serves as a local oscillator (LO) source supplying an Rx LO signal 105 to Rx optical circuitry 106 receiving an Rx optical line signal 102. The Rx optical circuitry 106 functions as a mixer by combining the Rx LO signal 105 from the Rx laser 104 with the incoming Rx optical line signal 102. This combination allows the extraction of a desired optical signal of one or more specific wavelengths. The Rx optical circuitry 106 facilitates coherent detection, enabling the extraction of both amplitude and phase information from the incoming optical signal 102, which is then directed to the photodetectors 108 for conversion into an electrical signal. This process is crucial for accurate signal processing and optimizing the signal-to-noise and distortion ratio (SNDR) in the receiver path 101-RX.

The photodetectors 108 are responsible for converting the optical signals received from the Rx optical circuitry 106 into photocurrents supplied to a transimpedance amplifier (TIA) 110, after which the received signals can be represented as voltages. The TIA 110 amplifies the electrical signals generated by the photodetectors 108 providing the necessary amplification for further processing by a high-speed analog-to-digital converter (HS-ADC) 112. The digital circuitry 114 is part of the ASIC/DSP/firmware section of the optical modem 100, which processes the digital signals converted by the HS-ADC 112. The digital circuitry 114 performs signal processing, error correction, and data management, ensuring that the received data is accurately interpreted and transmitted to downstream client devices.

The transmit path 101-TX in FIG. 1 begins with the digital circuitry 122, which processes data for transmission. The high-speed digital-to-analog converter (HS-DAC) 124 converts these digital signals into analog signals, which are amplified by a driver 126 prior to being converted and modulated by a modulator and optical circuitry 128 into optical signals. The modulator and optical circuitry 128 modulate the optical signal by combining it with a Tx LO signal 131 supplied by a Tx laser 130 that serves as a local oscillator source for modulation.

It will be appreciated that although the Rx laser 104 and Tx laser 130 are depicted as separate LO sources, in alternative embodiments, FIG. 1 can be adapted to use a single LO source that splits power between the receiver path 101-RX and transmit path 101-TX. In embodiments where the distribution of power can be adjusted in the receiver path 101-RX, the embodiments described below can be applied to a single LO source that adjusts power of the Rx LO signal 106 supplied to the receiver path 101-RX to achieve similar or equal results.

As noted earlier, challenges in the receiver path 101-RX include managing the power levels of the local oscillator source 104 to optimize SNDR while preventing damage to photodetectors 108 and the TIA 110 (or other types of amplifiers). Variations in responsivity over different wavelengths, aging, ambient temperature, or other environmental or physical changes can lead to fluctuations in photocurrent produced by the photodetectors 108, posing risks of overload to the photodetectors 108 and/or the TIA 110.

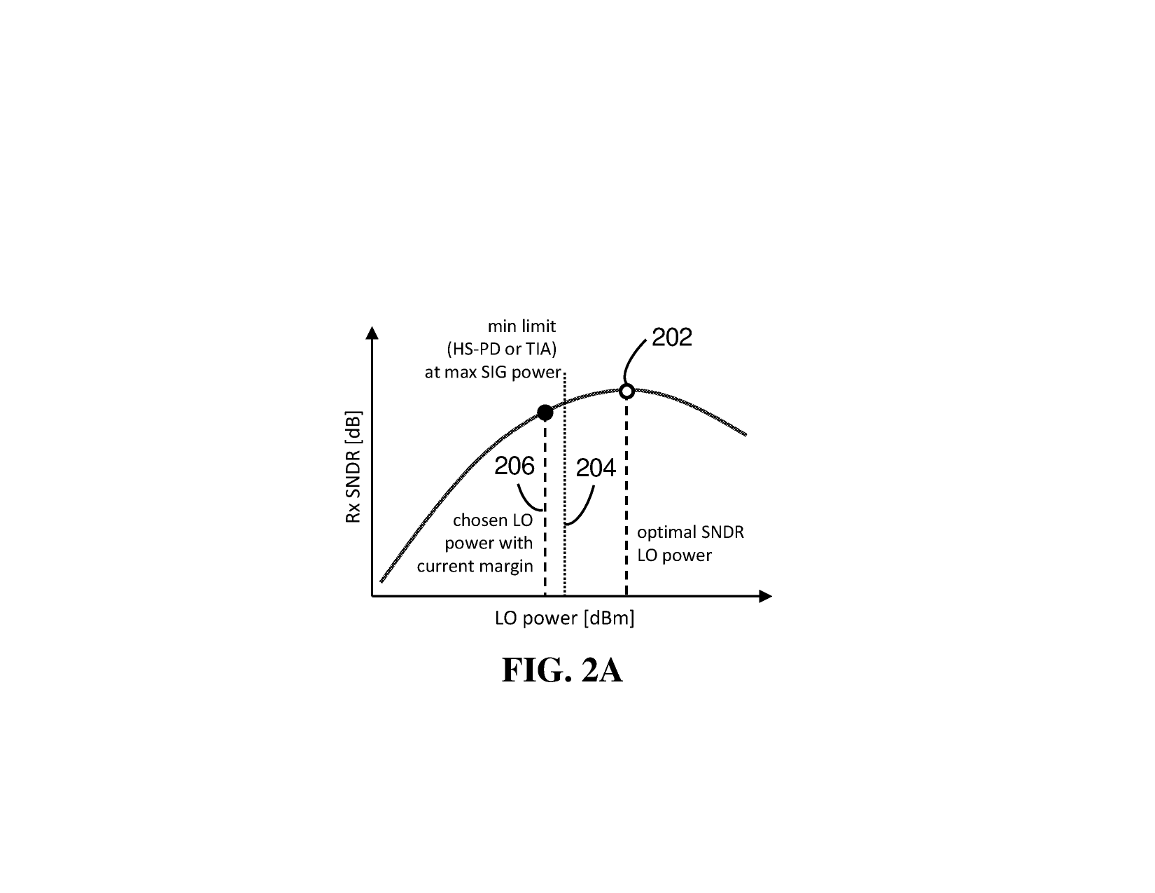

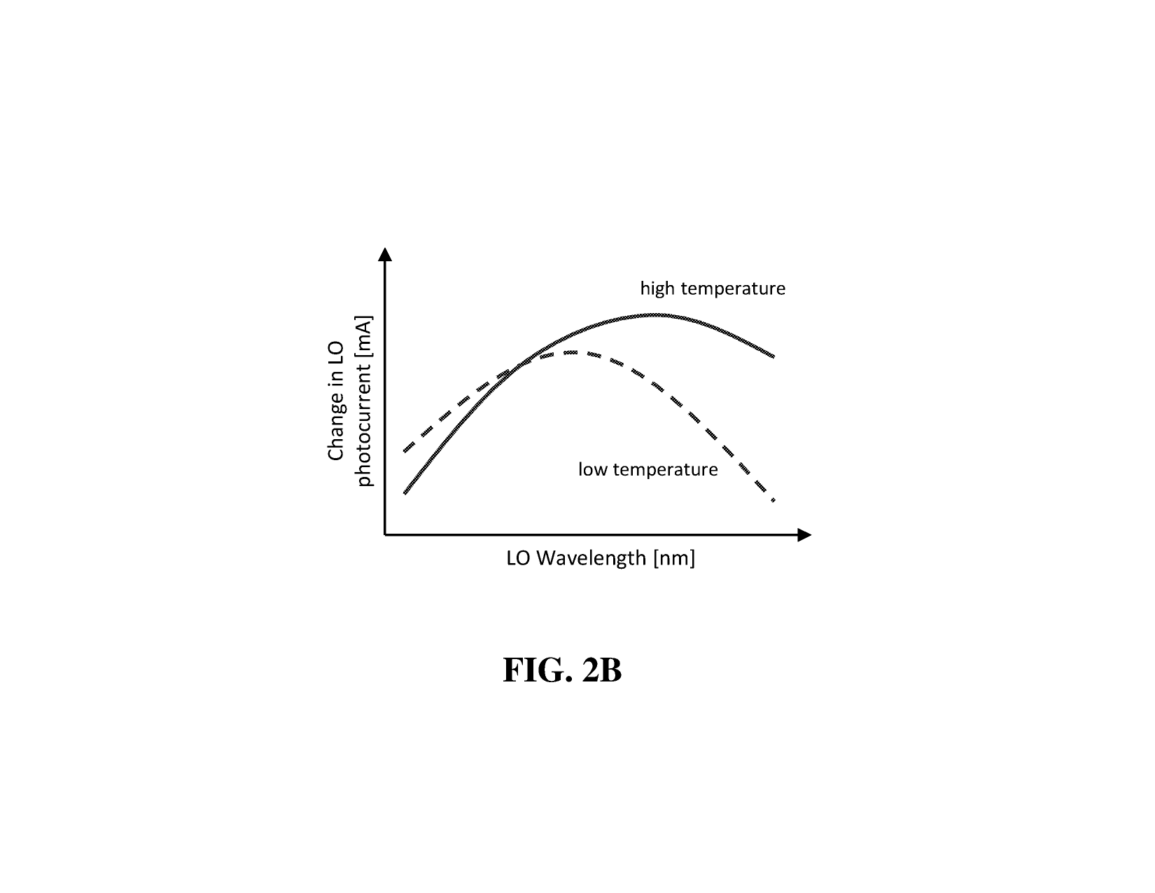

FIGS. 2A and 2B show plots illustrating exemplary, non-limiting embodiments depicting operations of an optical modem 100 in accordance with various aspects described herein. Referring FIG. 2A, during operations of the optical modem 100 in the receiver path 101-RX, SNDR rises as LO power of the Rx LO signal 105 increases because AC signal beat current rises with LO power faster than most noise sources. In optical modem applications, signal beat current refers to the interference that occurs when two optical signals of similar frequencies mix together, creating a beat frequency. Beat frequency can include unwanted noise terms that can cause distortions and degrade the performance of the communication system. LO RIN (Relative Intensity Noise) however rises faster than signal beat current and thus there is a global Rx SNDR maximum 202 (denoted by an open circle) after which performance decreases. Ideally, the optical modem 100 could cause the Rx laser 104 to set LO power of the Rx LO signal 105 to this maximum, but too much input photocurrent may overload the photodetector 108 or the TIA 110 front-end (possibly causing damage) beyond an overload current threshold 204 that may occur below the SNDR maximum 202. To avoid an overload, the optical modem 100 can be configured to set an upper LO power limit 206 with some margin up to the overload current threshold 204 that maximizes Rx SNDR locally (depicted by solid dot). Referring FIG. 2A, despite a coarse wavelength grid, firmware must still tune wavelength while LO responsivity—and thus downstream photocurrent—varies over wavelength, sometimes by several dB depending on the wavelength tuning change and operating temperature (see low to high temperature ranges). When wavelength changes it may cause the photocurrent to encroach the overload current safety margin shown in FIG. 2A, and so it would be beneficial for the receiver path 101-RX to include a control loop to both maximize SNDR and protect the photodetector 108 or the TIA 110.

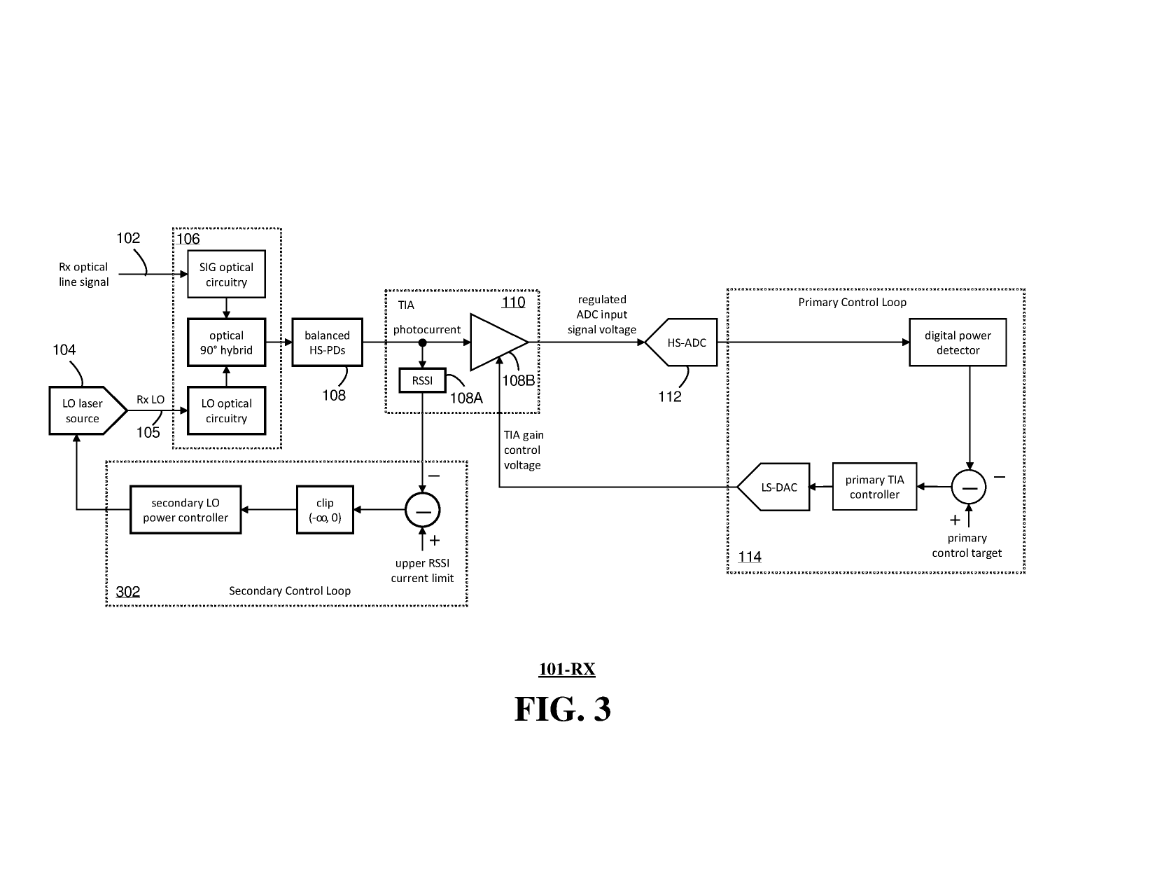

FIG. 3 is a block diagram illustrating an exemplary, non-limiting embodiment of an adaptation of the receiver path 101-RX of the optical modem 100 of FIG. 1 in accordance with various aspects described herein. The receiver path 101-RX comprises the Rx optical circuitry 106, which includes a signal (SIG) optical circuitry, an optical 90-degree hybrid and LO optical circuitry. The optical 90-degree hybrid is used to combine the Rx LO signal 104 conditioned by the LO optical circuitry with the incoming optical signal 102. The optical 90-degree hybrid splits the combined signal into two orthogonal components (e.g., In-Phase (I) and Quadrature (Q) phases), which are then directed to balanced high-speed photodiodes (HS-PDs) 108. The photocurrent generated by the balanced HS-PDs 108 is supplied to the TIA 110, which includes a detector 108A (illustrated as a Received Signal Strength Indicator or RSSI; herein RSSI detector 108A) that measures the photocurrent supplied to amplifier stages 108B of the TIA 110 whose gain is controlled by the digital circuitry 114. The digital circuitry 114 performs the function of a primary control loop that regulates the HS-ADC 112. For illustration purposes, the digital circuitry 114 will be referred to as the primary control loop 114.

The primary control loop 114 measures signal power utilizing a digital power detector, which is supplied to a TIA controller that utilizes an LS-DAC (Low Speed Digital to Analog Converter) to control gain of the TIA 110 and thereby regulates HS-ADCs 112 input voltage. The primary control loop 114 includes an error signal and primary control target signal to minimize error in the primary control loop 114. The primary control target signal shown in the primary control loop 114 can be calibrated at the time of manufacturing the optical modem 100 and can be adjusted during modem operation via firmware and/or hardware according to field temperature, age, characteristics of the optical signal being received (e.g., its format and/or levels), bandwidth of the optical signals, or other factors.

To achieve the objective of maximizing SNDR and protect the photodetector 108 and/or the TIA 110, the optical modem 100 includes a secondary control loop 302. The secondary control loop 302 is enabled to direct the LO laser source 104 to raise LO power of the Rx LO signal 105 near the overload threshold 204 of FIG. 2A, thereby in turn raising SNDR of the receiver path 101-RX. The primary control loop 114 continues to regulate the input voltage of the HS-ADC 112 even as the secondary control loop 302 causes the LO Laser source 104 to adjust LO power of the Rx LO signal 105. In one embodiment, the secondary control loop 302 adjusts power of the Rx LO signal 105 to alter the downstream signal beat current generated in the HS-PDs 108. The secondary controller 302 is further configured to adjust power of the Rx LO signal 105 to mitigate changes in the main receiver (Rx) signal (SIG) 102. The secondary control loop 302 can perform other functions as will be described below, which collectively are intended to increase SNDR on the receive path 101-RX while preventing an overload condition at the photodetector 108 and/or the TIA 110.

It will be appreciated that the primary control loop 114 cannot regulate the input photocurrent of the TIA 110 because the primary control loop 114 has neither the required sensor (on TIA 110 input photocurrent) nor the required control (LO power) at the LO laser source 104. Thus, the receiver path 101-RX benefits from the secondary control loop coupled to the input of the TIA 110 to control the LO laser power of the LO laser source 104 directly or by some intermediary optical method.

To perform these functions, the secondary loop controller 302 includes a comparator to compare an upper RSSI current limit to the RSSI measurement, a clip (-∞, 0) element, and a secondary LO power controller. The upper RSSI current limit sets a maximum allowable current level for the RSSI measurement to protect the HS-PDs 108 and/or the TIA 110 from photocurrent overload while optimizing SNDR. The clip (-∞, 0) element ensures that the adjustments made by the secondary control loop 302 do not exceed predefined limits. The secondary LO power controller (microprocessor, ASIC or other computing device) directs the LO laser source 104 to adjust the power of the Rx LO signal 105 either directly via laser bias current or by indirect optical attenuation. This adjustment helps to maintain optimal performance of SNDR and prevents overload in the HS-PDs 108 and/or the TIA 110. The secondary control loop 302 is typically digital and runs in firmware, but other embodiments are possible including those implemented entirely in the analog domain or integrated directly into ASIC logic. The secondary control loop 302 can be implemented as Proportional-Integral-Derivative (PID), a lead/lag compensator, a Linear Quadratic Regulator (LQR), or other types of control loop feedback configurations.

It will be appreciated that the adjustments performed by the primary control loop 114 to regulate HS-ADCs 112 input voltage and adjustments made by the secondary control loop 302 to regulate power generate by the LO laser source 104 can occur at a substantially equal rate. In other embodiments the secondary control loop 302 can operate at slower rate than the adjustments made by the primary control loop 114. It will be further appreciated that in order to provide the secondary loop controller 302 the ability to adjust the LO power of the Rx Laser 104, in one embodiment, the Rx Laser 104 is not shared with the transmitter path 101-TX. However, as was mentioned earlier, the subject disclosure can be applied to a single LO source split between the receiver path 101-RX and transmit path 101-TX when the power supplied to the receiver path 101-RX is adjustable by the secondary control loop 302.

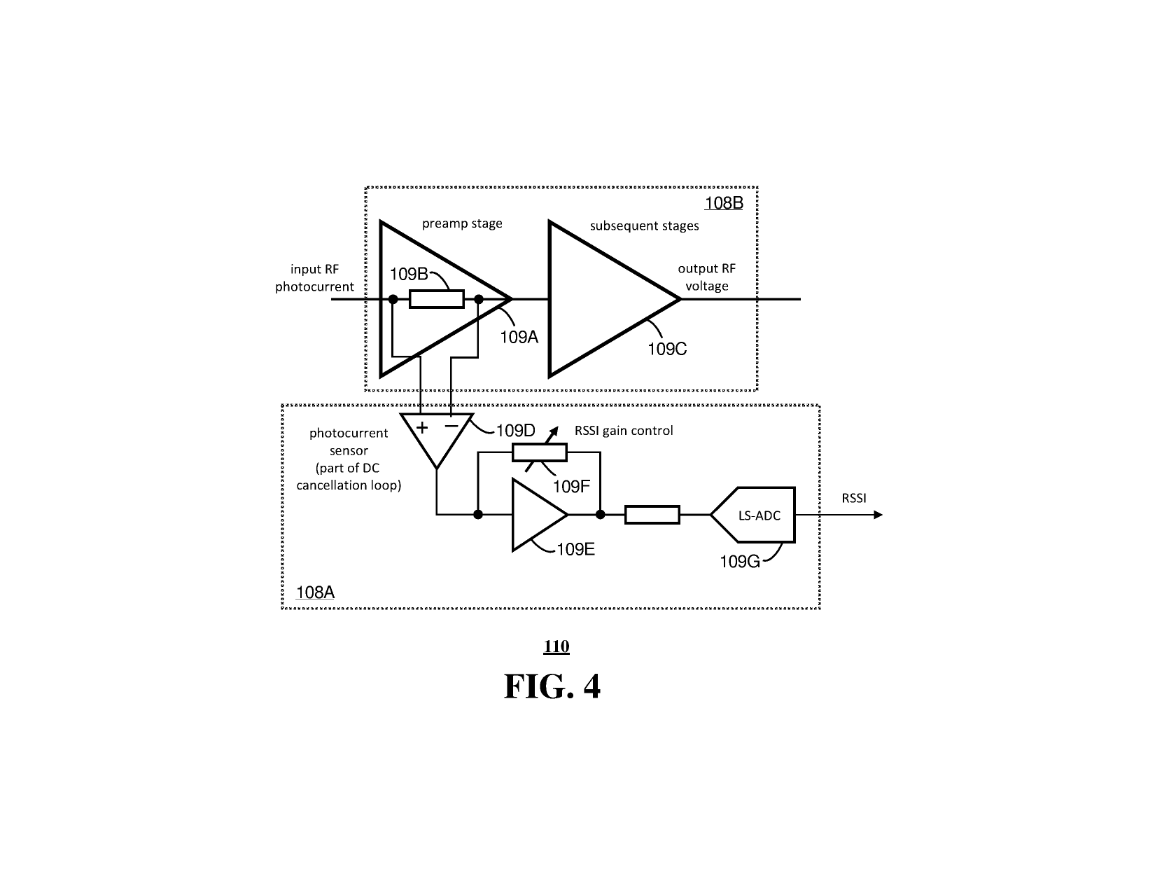

FIG. 4 is a block diagram illustrating an exemplary, non-limiting embodiment of the TIA 110 of the optical modem 100 of FIG. 3 in accordance with various aspects described herein. The amplifier 108B of the TIA 110 includes a preamp stage 109A that contains a DC-cancellation loop that senses with a photocurrent sensor 109D input photocurrent using a voltage drop across a resistive (and possibly active) element 109B of the preamp stage 109A. This voltage difference passes through a variable gain amplifier buffer stage 109E (with possibly active elements) and into a low-speed analog to digital converter (LS-ADC) 109G integrated inside the TIA 110, which firmware reads periodically using a protocol like the serial peripheral interface (SPI) or similar. The variable gain amplifier buffer stage 109E also includes an RSSI gain control 109F that can be controlled by the secondary control loop 302 (or other firmware in the optical modem 100) to adjust the fidelity of the RSSI measurement. Note that FIG. 4 illustrates conversion to the digital domain via the LS-ADC 109G. In alternative embodiments, the secondary control loop 302 (or other firmware in the optical modem 100) can be adapted to use the analog RSSI signal directly. The input RF photocurrent supplied to the preamp stage 109A continues downstream to subsequent gain stages 109C including the gain-control stage used by the primary control loop 114.

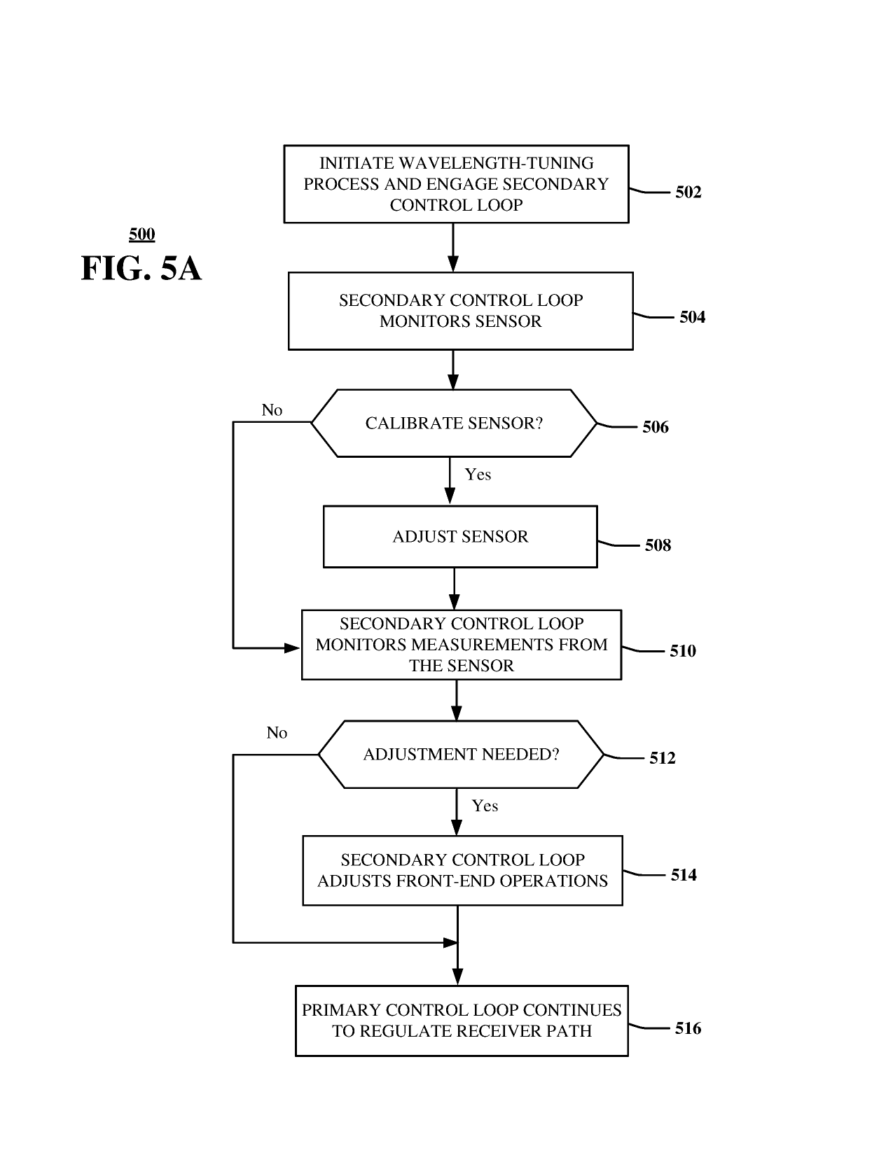

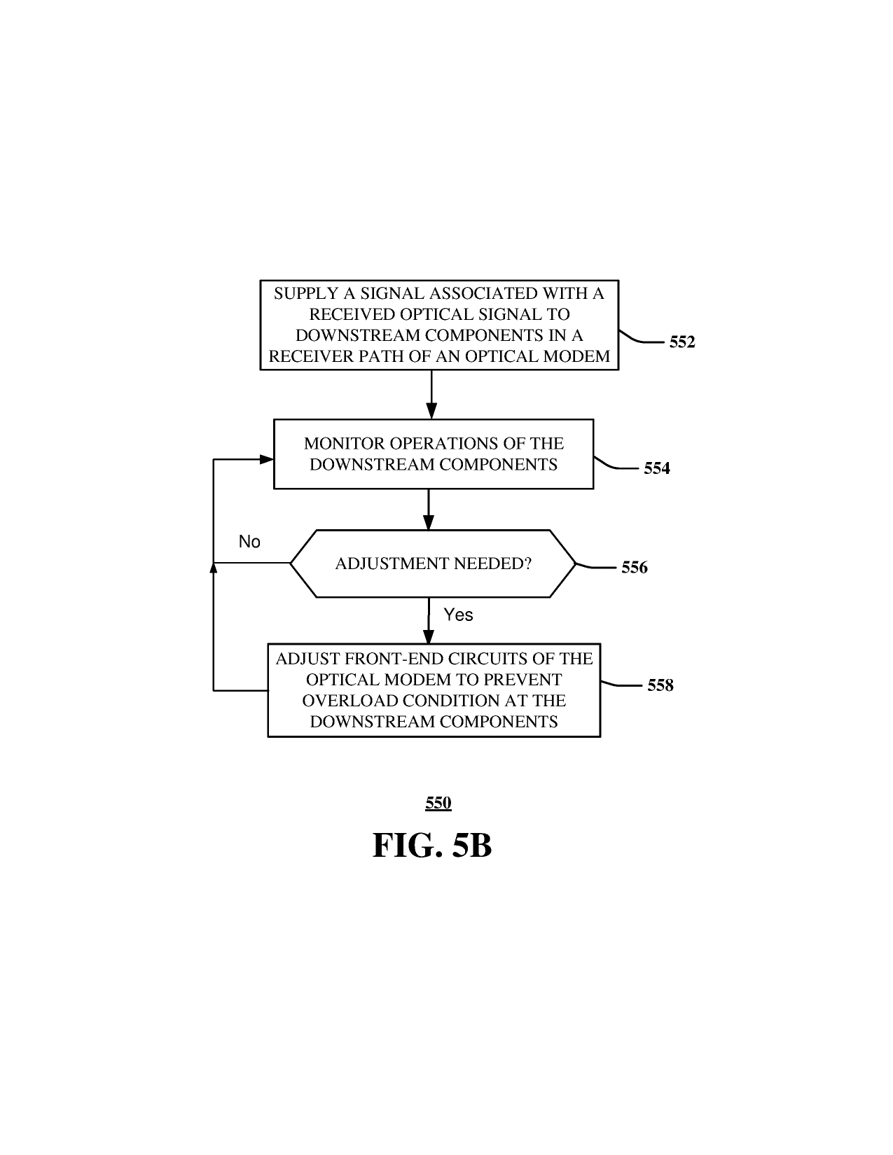

FIG. 5A depicts an illustrative embodiment of a method 500 utilized by an optical modem in accordance with various aspects described herein. The process begins at step 502, where wavelength tuning process is initiated by a receive path of the optical modem, which engages a secondary control loop to monitor operations of one or more components (e.g., photodetectors and/or amplifiers) of the receive path to ensure these components do not experience an overload condition. At step 504, the secondary control loop (or other firmware or control loops in the optical modem) monitors the performance of a sensor (e.g., RSSI detector) coupled to the one or more components being monitored. The sensor generates measurements associated with one or more signals (e.g., photocurrent and/or voltages) of the components. At step 506, the secondary control loop (and/or other firmware) can determine if the sensor needs calibration to improve the fidelity of these measurements. If so, the process moves to step 508 where the sensor is adjusted (e.g., recalibrating a variable gain control of an RSSI detector) to improve the fidelity of the measurement generated by the sensor to arrive at a new baseline value.

If it is determined at step 506 that an adjustment is not necessary, the process turns to step 510 where the secondary control loop monitors measurements from the sensor to determine if the tuning process started at step 502 and adjusted by a primary control loop at step 516 to optimize the performance of the optical modem (e.g., SNDR) may lead to an overload condition at the one or more components (e.g., see FIG. 2A). If at step 512 the secondary loop controller detects that the tuning process or other factors may create an overload condition, the secondary loop controller will proceed to step 514 where it will adjust front-end operations of the optical modem (e.g., cause a laser to adjust its output power) to prevent the overload condition (e.g., reduce photocurrents supplied to an amplifier in the receive path) from occurring. If an overload condition is not anticipated in step 512, method 500 proceeds to step 516 where the primary control loop continues to regulate the receiver path (e.g., HS-ADC input signal voltage). The aforementioned steps are repeated during the tuning process.

While for purposes of simplicity of explanation, the respective processes are shown and described as a series of blocks in FIG. 5A, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 5B depicts an illustrative embodiment of a method 550 utilized by an optical modem in accordance with various aspects described herein. The process begins at step 552, where a received signal is generated from an optical line signal by, for example, an optical mixer. The received signal is then supplied to downstream components (e.g., photodetectors and/or amplifiers) in the receive path of an optical modem. The downstream components process the received signal to generate a converted and amplified signal operating in the electrical domain. At step 554, operations of the downstream components are monitored with detection circuitry (e.g., RSSI detector) to determine if such components are operating within their operational range. The method then proceeds to decision step 556, where it is determined whether an adjustment is needed to avoid exceeding an operational threshold of one or more of downstream components in the receiver path of the optical modem. If an adjustment is required, the process moves to step 558, where front-end circuits of the optical modem are adjusted. The front-end circuits may be, for example, a LO laser source which is adjusted to change characteristics of a LO signal supplied by the LO laser source to the circuity generating the received signal (e.g., optical mixer). The adjusted characteristics of the LO signal can include an adjustment in power, wavelength, or other suitable characteristics. Such an adjustment helps to improve the SNDR of the optical modem while preventing an overload condition of the downstream components. The method repeats these steps, ensuring optimal performance and protection of the downstream components.

While for purposes of simplicity of explanation, the respective processes are shown and described as a series of blocks in FIG. 5B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method performed by an optical modem, comprising:
mixing a local oscillator (LO) signal produced by a LO source and an incoming optical signal to produce a received optical signal;
directing the received optical signal to one or more photodetectors to produce a photocurrent that is supplied to an amplifier;
monitoring the photocurrent supplied to the amplifier; and
responsive to the monitoring, causing the LO source to perform an adjustment of an optical power of the LO signal to control the photocurrent supplied to the amplifier.

2. The method of claim 1, wherein the adjustment of the optical power of the LO signal prevents the photocurrent produced by the one or more photodetectors from exceeding an operational threshold.

3. The method of claim 1, wherein the adjustment of the optical power of the LO signal adjusts the photocurrent produced by the one or more photodetectors on a signal path to improve operation of an analog-to-digital converter (ADC) coupled to the amplifier.

4. The method of claim 1, wherein the monitoring the photocurrent is performed by a detection circuit that performs a measurement of the photocurrent.

5. The method of claim 4, wherein the detection circuit comprises a received signal strength indicator (RSSI) circuit.

6. The method of claim 4, wherein the detection circuit has a tunable gain.

7. The method of claim 6, further comprising adjusting the tunable gain of the detection circuit to adjust the measurement produced by the detection circuit.

8. The method of claim 4, wherein the detection circuit is coupled to a pre-amplifier stage of the amplifier.

9. The method of claim 1, wherein the amplifier comprises a transimpedance amplifier.

10. The method of claim 1, wherein the amplifier has a tunable gain adjustable by a primary control loop, wherein the adjustment of the optical power of the LO signal is performed by a secondary control loop, and wherein the adjustment of the optical power of the LO signal by the secondary control loop occurs at a substantially equal or slower rate than adjusting the tunable gain of the amplifier by the primary control loop.

11. The method of claim 1, wherein the LO source is not shared with a transmitter of the optical modem.

12. The method of claim 1, further comprising tuning a wavelength of the LO source to match the incoming optical signal.

13. An optical modem, comprising:
a local oscillator (LO) source configured to produce a LO signal;
a mixer configured to mix the LO signal and an incoming optical signal to produce a received optical signal;
one or more photodetectors configured to produce a photocurrent from the received optical signal;
an amplifier configured to generate an output signal based on the photocurrent; and
a controller performing operations comprising:
monitoring the photocurrent supplied to the amplifier; and
responsive to the monitoring, causing the LO source to perform an adjustment of an optical power of the LO signal to control the photocurrent supplied to the amplifier.

14. The optical modem of claim 13, wherein the adjustment of the optical power of the LO signal prevents the photocurrent produced by the one or more photodetectors from exceeding an operational threshold.

15. The optical modem of claim 13, further comprising a detection circuit configured to produce a measurement for monitoring the photocurrent supplied to the amplifier.

16. The optical modem of claim 15, wherein the detection circuit comprises a received signal strength indicator (RSSI) circuit.

17. The optical modem of claim 15, wherein the detection circuit has a tunable gain, and wherein the operations of the controller further comprise adjusting the tunable gain of the detection circuit to adjust the measurement produced by the detection circuit.

18. A non-transitory machine-readable medium, comprising executable instructions that, when executed by a processing system including a processor, facilitate performance of operations, the operations comprising:
monitoring a measurement associated with a photocurrent supplied to an amplifier, wherein the photocurrent is produced by one or more photodetectors according to a received optical signal produced by mixing a local oscillator (LO) signal produced by a LO source and an incoming optical signal; and
responsive to the monitoring, causing the LO source to perform an adjustment of an optical power of the LO signal to control the photocurrent supplied to the amplifier.

19. The non-transitory machine-readable medium of claim 18, wherein the adjustment of the optical power of the LO signal prevents the photocurrent produced by the one or more photodetectors from exceeding an operational threshold.

20. The non-transitory machine-readable medium of claim 18, wherein the measurement is produced by a detection circuit of the amplifier.
